(19) United States
(12) Patent Application Publication
(10) Pub. No.: US 2003/0185944 A1
(43) Pub. Date: Oct. 2, 2003

(54) Savory kit and method for making a savory meal

(76) Inventor: Michael Steven Zelski, Deerfield, IL (US)

Correspondence Address: UNILEVER, PATENT DEPARTMENT, 45 RIVER ROAD, EDGEWATER, NJ, 07020, US

(21) Appl. No.: 10/108,831

(22) Filed: Mar. 28, 2002

(51) Int. Cl. A23B 4/00

(52) U.S. Cl. 426/120

(57) ABSTRACT

A kit for making a savory meal is described. The kit has IQF vegetables and a dry, free-flowing powder that can be added to a boiling liquid to produce a savory meal in under 25 minutes.

### FIELD OF THE INVENTION

The present invention is directed to a kit for a savory meal as well as a method for making the savory meal. More particularly, the kit comprises uncooked vegetables in combination with a dry, free-flowing flavor enhancing powder. The kit may be added to a liquid, like water, to make a savory meal, ready to serve, in under about 25 minutes.

### BACKGROUND OF THE INVENTION

Many food establishments, like restaurants, school cafeterias and hospital kitchens, utilize pre-packaged and frozen foods that can be easily cooked. Typically, well liked foods such as cooked meats, pastas, potatoes and vegetables are individually quick frozen (IQF) then cooked in a base like a sauce, gravy, soup stock or the like along with desired spices. Subsequent to cooking in the base, the resulting savory meal is cooled, packaged, then frozen, in the form of a solid block, in a conventional freezable package.

In order to prepare (for serving) the savory meal conventionally prepared and packaged as a frozen solid block, chefs and cooking assistants typically have to boil the frozen solid block for about two (2) hours before the desired savory meal is ready to eat. The two hours of boiling are required so that the base, which makes up the crux of the frozen solid block, is transformed into a liquid or slurry-like base suitable for eating.

Unfortunately, savory meals prepared in the above-described manner are not fast cooking and typically result in a savory meal that is not fresh looking since the contents of the frozen solid block are cooked at least two times prior to serving. Particularly, vegetables prepared in the above-described savory meals almost never look fresh and green.

It is of increasing interest to prepare a kit for a savory meal that results in an excellent tasting and fresh looking meal. This invention, therefore, is directed to a kit for a savory meal whereby the kit may be added to a liquid, like water, to make a meal, ready to serve, in under about 25 minutes.

### ADDITIONAL INFORMATION

Efforts have been disclosed for making frozen foods. In U.S. Pat. No. 6,235,330, free-flowing and coated frozen foods are described.

Other efforts have been disclosed for making frozen foods. In U.S. Pat. No. 6,004,601, IQF green vegetables that are subjected to a zinc blanch solution are described.

Still other efforts have been disclosed for making frozen foods. In U.S. Pat. No. 5,723,167, compressed frozen vegetables are described.

None of the additional information describes a kit having uncooked vegetables and dry, free flowing flavor enhancing powder.

### SUMMARY OF THE INVENTION

In a first aspect, the present invention is directed to a kit for making a savory meal, the kit comprising:

a) an individually quick frozen cooked meat, individually quick frozen vegetable, or both; and

b) a dry, free-flowing flavor enhancing powder

wherein the IQF cooked meat or the IQF vegetable or both have not been cooked in a liquid prior to packaging, further wherein the kit is substantially free of liquid or frozen liquid.

In a second aspect, the present invention is directed to a method for making a savory meal.

Not been cooked in a liquid, as used herein, is defined to mean not boiled until cooked in a liquid after being individually quick frozen. Meat, as used herein, is defined to include beef, poultry, pork, lamb and fish. Dry, as used herein, is meant to mean less than about 10.0% by weight water, and preferably, less than about 3.0% by weight water to substantially no water. Powder, as used herein, is defined to mean a non-agglomerated dry solid, and free-flowing means not suitable to always stick (i.e., pourable) to a polymeric package. Substantially free of liquid or frozen liquid means no liquid or frozen liquid base (i.e., stock) is within the kit.

### DETAILED DESCRIPTION OF THE PREFERRED EMBODIMENTS

There is no limitation with respect to type of IQF cooked meat that may be used in this invention other than that the meat may be consumed by humans. Such a meat can include beef, chicken, turkey, lamb, pork, duck, fish, shrimp, clam, lobster, mixtures thereof and the like.

Regarding the IQF vegetables suitable for use in this invention, such vegetables can include broccoli, cauliflower, carrots, spinach, asparagus, legumes, squash, peas, corn, mixtures thereof and the like.

When preparing the IQF cooked meat, typically, the meat is first cooked by baking, boiling, frying steaming, sauteing, barbecuing or the like, then cut or diced. The cooked meat is then subjected to an individually quick freeze apparatus designed to allow continuous production of high quality frozen food product.

The vegetables employable in this invention are typically first blanched with boiling water so that any enzymes associated with the same may be deactivated. Often, the blanching of the vegetables is for less than about 2.0 minutes, and preferably less than about 1.5 minutes. Subsequent to blanching, the vegetables are subjected to an individually quick freeze apparatus to produce high quality frozen food product.

Often, and in an especially preferred embodiment, IQF pasta, rice, potato or a combination thereof may be added to the kit of the present invention, in lieu of or in addition to the IQF cooked meat.

There is no limitation with respect to how the IQF process is carried out or how the IQF apparatus is used, as long as IQF cooked meat, and IQF vegetables can be recovered. Typically, such processes involve a cryogenic liquid or gas that is contacted with food in an apparatus having a tunnel or contact portion for the meats, vegetables or both to run through. Nitrogen and carbon dioxide are often the preferred materials suitable for use in the IQF process. In an especially preferred embodiment, the cooked meats, and the vegetables (being subjected to the IQF process) are about bite size (e.g., dimensions from about 0.5 cm to about 7.5 cm). A more detailed description of the process for making IQF meats and vegetables is described, for example, in U.S. Pat. Nos. 5,520,004 and 5,723,167, the disclosures of which are incorporated herein by reference.

Regarding the flavor enhancing powder that may be used in this invention, any commonly known flavor, spice or mixture thereof may be used. Such a powder may comprise salt, pepper salt, celery salt, parsley, sage, turmeric, onion powder, garlic powder, curry, poultry seasoning, basil, oregano, ground celery, pepper, thyme, autolyzed yeast extract (AYE), bay leaf, tomato powder, creole seasoning, butter flavor, artificial fish or clam flavor, beet powder, fennel, ground marjoram, carrot powder, broccoli powder, nutmeg, cheese powder, sugar, egg yolk, cheese booster, mixtures thereof and the like.

Other ingredients which may be used in the flavor enhancing powder of the present invention include vegetable fats, like commercially available hydrogenated vegetable fats; thickeners, like dextrin, maltodextrin, flour, corn starch, milk powder, and starch thickener; non-dairy creamer; oil. Still other ingredients which may be used in the dry, free-flowing enhancing powder of the present invention include acids, like citric acid, and flowing agents such as calcium silicate, tricalcium phosphate, calcium stearate, sodium silico-aluminate, mixtures thereof and the like.

Even other additives which may be used in the dry, free-flowing powders of the present invention include pastes or purees. Illustrative pastes or purees which may be used in this invention include those comprising tomato, pumpkin, broccoli, squash, cucumber, mixtures thereof and the like.

The combination of the ingredients used in the dry, free-flowing powder of the present invention is limited only to the extent that after cooking, a savory product suitable for human consumption is produced. In an especially preferred embodiment, however, the powder of the present invention is less than about 25.0% by weight fat, and preferably, from about 0.5 to about 20.0% by weight fat, based on total weight of the powder and including all ranges subsumed therein. In yet another especially preferred embodiment, the dry, free-flowing powder of the present invention has from about 0.01 to about 2.5% by weight of flowing agent, based on total weight of the powder and including all ranges subsumed therein.

The dry, free-flowing powder of the present invention often has less than about 10.0% by weight water (based on total weight of the powder), but preferably has less than about 3.0% by weight water to substantially no water. Most preferably, therefore, the water content of the dry, free-flowing powder does not exceed the amount of water absorbed by the powder from the atmosphere prior to packaging plus the amount of water mixed into the powder when dry ingredients are being mixed with paste, puree or both. When preparing such a powder, any commercially known mixing vessel may be employed, as long as a relatively homogenous powder is produced.

When packaging the contents (e.g., meat, vegetable and powder) in the kit of the present invention, typically the kit will comprise from about 5.0 to about 85.0, and preferably, from about 10.0 to about 80.0, and most preferably, from about 15.0 to about 70% by weight powder, based on total weight of the kit and including all ranges subsumed therein. In an especially preferred embodiment, the kit is rectangular in shape, with neither the length nor width exceeding 35 cm, and the kit is less than about 10.0 lbs, preferably, less than about 5.0 lbs.

When preparing or assembling the kit of the present invention, preferably, a Form/Film/Seal machine is used, such as those made commercially available by suppliers like Bosch, Tiromat, and Universal Packaging. Typically, the desired contents of the savory kit are fed into a food grade pouch (like a thermoplastic pouch) which is pulled or carried to a complementary sealing film which seals the pouch with the desired contents therein. Preferably, at about the time the pouch and sealing film meet, a vacuum manifold removes substantially all of the air in the headspace of the sealed pouch to produce a vacuum packed kit comprising IQF cooked meat or IQF vegetable or both as well as dry, free-flowing flavor enhancing powder. The resulting savory kit may be labeled with, for example, an ingredient label or the list of ingredients may be printed directly on the packaging. Illustrative machines that may be used to make the kits of the present invention are disclosed in U.S. Pat. No. 4,951,444, the disclosure of which is incorporated herein by reference.

It is noted herein that the meat, vegetable or both may be mixed with the dry, free flowing flavor enhancing powder prior to packaging or while packaging. In an especially preferred embodiment, however, the powder is not mixed with any meat or vegetable in the package but isolated from the same in the packaging. In another especially preferred embodiment, the kit of the present invention is frozen and remains frozen until being cooked. It is particularly noted herein that the kit (or a case of kits) of the present invention, subsequent to being frozen, unexpectedly may remain frozen for a period of about 5 hours to about 8 hours, after being removed from a freezer or refrigeration device and left at room temperature.

When making the savory meal of the present invention, the chef or cooking assistant is instructed (via instructions supplied with the savory kit) to open the kit and empty the contents of the kit into a liquid (preferably a boiling liquid) and to cook (e.g., boil) the resulting mixture for under about 25 minutes, but preferably for about 10 minutes to about 20 minutes, and most preferably for about 12 minutes to about 16 minutes, including all ranges subsumed therein. After boiling, the resulting product is an excellent tasting and fresh looking meal, and particularly, because vegetable within the savory kit has been cooked for the first time. In an especially preferred embodiment, the chef or cooking assistant is instructed not to leave the contents of the savory kit at room temperature for more than about 8 hours.

There is no limitation with respect to how much liquid or the type of liquid used with the savory kit of this invention, as long as a savory meal can be produced. Typically, the liquid may be water or water mixed with fat-comprising and non-fat-comprising dairy creamers. The amount of liquid used is generally dictated by viscosity preferences of the chef or chef assistant, but often, for about every 1 part by weight of savory kit used, about 1 part to about 5 parts by weight of liquid is used to produce the savory meal.

The following examples are provided to facilitate an understanding of the present invention. The examples are not intended to limit the scope of the claims.

### EXAMPLES

Dry, free-flowing flavor enhancing powders were prepared by mixing, in no particular order, the following ingredients:

| Ingredient | Weight Percent |
|---|---|
| Vegetable fat | 5-10 |
| Tomato paste | 5-10 |
| Starch | 9-14 |
| Salt | 4-7 |
| Celery powder | 1-3 |
| Black pepper | 0.1-0.2 |
| Tomato powder | 8-12 |
| AYE | 2-5 |
| Onion powder | 0.1-1 |
| Carrot powder | 0.1-1 |
| Fennel | 0.05-0.5 |
| Citric acid | 0.05-0.5 |
| Beet powder | 0.05-0.5 |
| Garlic powder | 0.05-0.5 |
| Ground marjoram | 0.01-0.06 |
| Cayenne pepper | 0.05-0.1 |
| Ground thyme | 0.05-0.1 |
| Parsley | 0.05-0.3 |
| Calcium silicate | 0.5-2.0 |
| Maltodextrin | 40-50 |

Savory kits of garden vegetable soup were prepared by vacuum sealing the dry, free-flowing flavor enhancing powders made above with IQF vegetables and IQF potato in a weight ratio of about 3:5:2, respectively. The resulting kits were then frozen.

After freezing the kits, the kits were removed from the freezer and each kit was added to about 6 lbs. of boiling water (i.e., about 3 qts.) for about 15 minutes. Produced was an excellent tasting, fresh looking, garden vegetable soup.

What is claimed is:

1. A kit for making a savory meal, the kit comprising:
a) an individually quick frozen cooked meat, an individually quick frozen vegetable, or both; and
b) a dry, free-flowing flavor enhancing powder
wherein the IQF cooked meat or the IQF vegetable or both have not been cooked in a liquid prior to packaging, further wherein the kit is substantially free of liquid or frozen liquid.

2. The kit according to claim 1 wherein the kit further comprises IQF pasta, rice, potato or a combination thereof.

3. The kit according to claim 1 wherein the IQF cooked meat is beef, chicken, turkey, lamb, pork, duck, fish, shrimp, clam, lobster, or a mixture thereof.

4. The kit according to claim 1 wherein the IQF vegetable is broccoli, cauliflower, carrot, spinach, asparagus, a legume, squash, peas, corn or a mixture thereof.

5. The kit according to claim 1 wherein the IQF cooked meat or IQF cooked vegetable or both, and the dry, free-flowing powder may be boiled in a liquid and ready to serve in under about 25 minutes.

6. The kit according to claim 1 wherein the dry, free-flowing powder is less than about 10% by weight water.

7. The kit according to claim 1 wherein the dry, free-flowing flavor enhancing powder comprises flavor, spice, fat, thickener, flowing agent or a mixture thereof.

8. The kit according to claim 7 wherein the dry, free-flowing flavor enhancing powder comprises less than about 25.0 percent by weight fat.

9. The kit according to claim 7 wherein the dry, free-flowing flavor enhancing powder further comprises a puree or a paste.

10. The kit according to claim 1 wherein the kit is about 5.0 to about 85.0 percent by weight dry, free-flowing flavor enhancing powder.

11. The kit according to claim 1 wherein the kit is less than about 10 lbs.

12. The kit according to claim 1 wherein the IQF cooked meat or IQF vegetable or both, and the dry, free-flowing flavor enhancing powder are vacuum packed in a package.

13. The kit according to claim 12 wherein the IQF cooked meat or IQF vegetable or both are not mixed with the dry, free-flowing flavor enhancing powder in the package.

14. The kit according to claim 1 wherein the kit further comprises instructions to cook the IQF cooked meat or IQF vegetable or both and the dry, free-flowing flavor enhancing powder in a liquid for under about 25 minutes.

15. The kit according to claim 14 wherein the liquid comprises water and the liquid is brought to a boil to produce a savory meal.

16. A method for making a savory meal ready for serving comprising the steps of:
a) removing IQF cooked meat or an IQF cooked vegetable or both and a dry, free-flowing flavor enhancing powder from a packaged kit; and
b) adding the IQF cooked meat or the IQF cooked vegetable or both and the dry, free-flowing flavor enhancing powder to a liquid to produce a mixture wherein the liquid comprises water and the mixture is boiled for less than about 25 minutes in order to produce the savory meal.

17. The method according to claim 16 wherein the mixture is boiled for about 12 to about 16 minutes.

18. The method according to claim 16 wherein the packaged kit is frozen or able to remain frozen for about 5 to about 8 hours when left at room temperature.
